(19) United States
(12) Patent Application Publication
(10) Pub. No.: US 2023/0068901 A1
(43) Pub. Date: Mar. 2, 2023

(54) ADVANCED AVAILABLE-TO-PROMISE SUPPLY CREATION-BASED CONFIRMATION

(71) Applicant: SAP SE, Walldorf (DE)

(72) Inventors: Andras Kovacs, Mannheim (DE); Thomas Werth, Speyer (DE); Grzegorz Falinski, Northeim (DE); Dominik Herrmann, Sinsheim (DE); Jan Peter Ohst, Wiesloch (DE); Stefan Merker, Mannheim (DE); Pranit Bankar, Bangalore (IN); Yaswanth Datta Saikumar Vathumilli, Bangalore (IN); Christian Mohr, Ostringen (DE); Jibi Joseph Vadakayil, Sankt Leon Rote (DE)

(73) Assignee: SAP SE, Walldorf (DE)

(21) Appl. No.: 17/410,970

(22) Filed: Aug. 24, 2021

(51) Int. Cl. G06Q 10/06; G06Q 10/08

(52) U.S. Cl. CPC G06Q 10/06313; G06Q 10/087; G06Q 10/06311; G06Q 10/06315

(57) ABSTRACT

Certain embodiments of the disclosure concern a computer-implemented method. For a distributable product, the method can store a representation of a production process involving a plurality of prerequisites and input quality parameters, receive a request to promise availability of a first quantity of the product having specific instances of the input quality parameters, simulate production of a second quantity of the product having the specific instances of the input quality parameters, output one or more promised delivery terms, and reserve resources in a production system for production of the second quantity of the product. The second quantity is smaller than or equal to the first quantity.

### BACKGROUND

Available-to-promise (ATP) is an important feature implemented in some supply chain management, manufacturing, and fulfillment systems. Generally, ATP can provide a response to customer order inquiries based on resource availability. It can promise certain delivery terms (e.g., available quantities and delivery due dates) of a requested product. Thus, ATP can support order promising and fulfillment, manage demand and match it to production plans. ATP functions are IT-enabled and usually integrated into enterprise management software packages. In certain circumstances, ATP can anticipate future demand of certain products, and may compute quantities and availability dates of such products. In other circumstances, ATP can dynamically allocate resources in response to actual customer orders. Implementation of ATP function in an enterprise resource planning (ERP) system is highly complex because it requires modeling the entire supply chain and manufacturing process, and the system has to re-run the calculations of that model for each new order, in the context of all the other (and potentially competing) orders received. The task becomes even more challenging when a customer expects to receive the promised delivery terms without a long delay or in “real-time,” e.g., within a few seconds after submitting an order. Thus, room for improvements exists for more advanced ATP function in an ERP system.

### BRIEF DESCRIPTION OF THE DRAWINGS

FIG. 1 is an overall block diagram of an example system for implementing advanced ATP supply-creation based confirmation function.

FIG. 2 is a block diagram of an example system integrating the advanced ATP supply-creation based confirmation function in an ERP system.

FIG. 3 is a flowchart illustrating an example overall method of implementing the advanced ATP supply-creation based confirmation function.

FIG. 4 is a block diagram illustrating an example high-level process flow occurred when performing the advanced ATP supply-creation based confirmation function.

FIG. 5 is a block diagram illustrating an example process flow occurred when performing the advanced ATP supply-creation based confirmation function using timeseries.

FIG. 6 is a block diagram depicting an example system configured to generate timeseries.

FIG. 7 is a block diagram of an example computing system in which described embodiments can be implemented.

FIG. 8 is a block diagram of an example cloud computing environment that can be used in conjunction with the technologies described herein.

### DETAILED DESCRIPTION

### Example 1—Overview of Available-to-Promise Function

ATP is an enterprise function that provides a response to order fulfillment enquiries in sales and distribution (SD) and production planning (PP)/detailed scheduling (DS). The order fulfillment enquiries include required materials and plants, as well as their respective requested quantities and dates. The result of the ATP check is typically based on the current stock situation and any future, anticipated or planned stock receipts and takes concurrent orders into account. Furthermore, additional restrictions based on any other order attributes (like region or customers) can be applied. The ATP function can generate confirmation proposals for the requested material and plant, including confirmed quantities and dates.

The connection between SD and PP/DS is crucial from an organizational perspective. Unfortunately, these components are often separated into different organizational units which have different priorities regarding the supply chain. For example, people in the sales department may prioritize fulfilling every customer request on time and with full quantity, whereas people in the planning department may place priority on reducing waste and production time, consolidating production lines, and optimizing resource utilization. Thus, it is important to choose a planning strategy that is designed to achieve an optimal balance between the sales and production priorities.

Conventionally, ATP focuses more on sales (e.g., the ATP processes are typically demand driven) than production planning (e.g., assemble to order/finish to order, make to order, configure to order, engineer to order, etc.). For more efficient ERP management, it is desirable for the ATP to support more production focused capabilities so that it not only can fulfill customer order, but also optimize material flow within the organization.

Thus, it would be advantageous for an ERP system and related methods for implementing an improved ATP function that achieves more balanced priorities between SD and PP/DS. As described below, one example is to integrate conventional ATP function with a supply creation-based confirmation (SBC) process. Such improved ATP technologies can be applied across a wide variety of enterprise software environments.

### Example 2—Example Overview of a System for Implementing Advanced Available-to-Promise Supply Creation-Based Confirmation

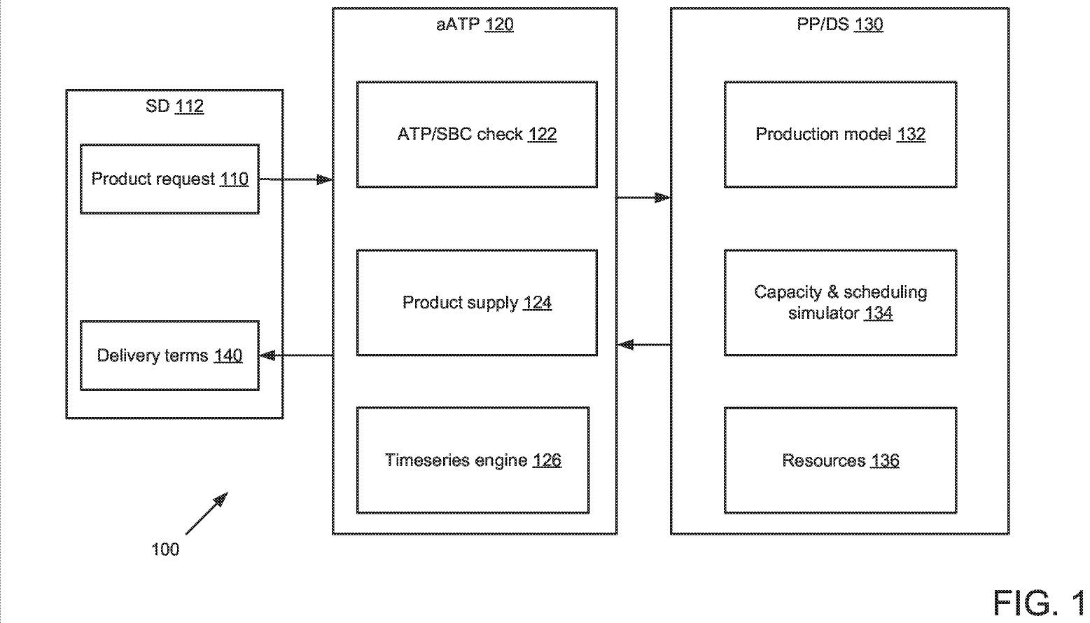

FIG. 1 shows an overall block diagram of an example system 100 configured to implement advanced ATP (aATP) integrated with the SBC process (also referred to as “aATP-SBC”). The system 100 can be a part of, or integrated with an ERP system, as described further below.

As shown, a product request 110 generated by a user (e.g., a sales representative) can be received by an aATP subsystem 120. In any of the examples herein, the product request 110 can be first submitted to a sales and distribution (SD) subsystem 112, which in turn sends the product request 110 to the aATP subsystem 120. The product request 110 can specify a desired quantity of a product having specific instances of input quality parameters (e.g., the product request can list thousands of quality parameters of the product which specify customized requirements regarding materials, dimensions, performance metrics, and the like).

The aATP subsystem 120 can include one or more objects, collectively denoted as “ATP/SBC check” 122, which work collaboratively to perform conventional ATP check and/or SBC availability check. The conventional ATP check can be performed based on evaluation of existing product supply 124, which includes current stock of the product and any future, anticipated or planned stock receipts for the product. The SBC availability check requires involvement of the PP/DS subsystem 130.

In certain scenarios (e.g., in make to order circumstances), the SBC availability check is always invoked (i.e., no need for conventional ATP check). In certain scenarios, the conventional ATP check is performed first to determine what quantity of the product can be provided by the existing product supply 124. If the requested quantity of the product cannot be fulfilled by the existing product supply 124, then the SBC check can be invoked to generate a delivery proposal for the remaining (i.e., unfulfilled) quantity of the product (e.g., a date/time when the remaining quantity of the requested product can be produced). Based on the ATP/SBC check 122, promised delivery terms 140 (i.e., available quantities and delivery due dates) of the requested product can be returned to the user (e.g., via the SD subsystem 112), who can then determine whether to place, update (e.g., shift delivery date into the future, reduce quantity, split proposals, etc.) or cancel the order for the requested product based on the promised delivery terms 140. As described herein, the ATP/SBC check 122 is configured to generate promised delivery terms 140 immediately after receiving the product request 110. Specifically, a time interval between receiving the product request 110 and outputting the promised delivery terms 140 is desirably less than a predefined duration. In general, the predefined duration can be less than 1 minute. The predefined duration can be within a few seconds (e.g., the predefined duration can be 10 seconds, 5 seconds, or 3 seconds, 1 second, etc.).

The PP/DS subsystem 130 is also referred to as a source of the requested product. In certain examples, the PP/DS subsystem 130 and the aATP subsystem 120 can be integrated within the same ERP system. In certain examples, the PP/DS subsystem 130 can be provided by a third party and is external to the aATP subsystem 120.

The PP/DS subsystem 130 can have a production model 132, which stores a representation of a production process involving a plurality of prerequisites and input quality parameters. For example, the production model 132 can quantify or characterize what resources are needed and what preparations are required before starting the production process, how a product is manufactured down to each component, the relationship between the components, the sequence of various production steps, and certain production constraints.

The PP/DS subsystem 130 can include a capacity and scheduling simulator 134. When the SBC availability check is invoked, as noted above, the capacity and scheduling simulator 134 can be configured to run a simulated production based on the production model 132. Such simulated production does not actually produce any product or its component. Instead, the output of the simulated production can provide a production capacity (e.g., what quantity of the product can be produced) and an estimated delivery time for a planned quantity of the product based on the simulated production schedule. As noted above, the planned quantity of the product can be the remaining quantity of the product that cannot be fulfilled by the existing product supply 124.

Optionally, the aATP subsystem 120 can include a timeseries engine 126 which is configured to generate timeseries of production availability. The time series engine 126 can run simulated production of certain products using various permutations of all possible quality parameters in the background or offline, even without receiving a request to run a simulated production. Thus, when the SBC availability check is invoked, as noted above, the timeseries engine 126 can immediately return a delivery proposal for the planned quantity of the product based on the previously generated timeseries corresponding to the specific input quality parameters, even before completion of the simulated production run by the capacity and scheduling simulator 134. In other words, generation of the delivery proposal based on the timeseries can be asynchronous to the simulated production. This can be particularly helpful in situations when the simulated production would take a long time (e.g., several minutes or even hours) to finish due to a very complex production model 132. Thus, based on timeseries, preliminary delivery terms 140 can be immediately presented to the user (thus reducing the user's wait time), while confirmation or modification of the promised delivery terms 140 can be presented to the user when the simulated production is completed. As such, the user can receive immediate feedback regarding product availability. While the timeseries engine 126 can also be placed within the PP/DS subsystem 130, placing the timeseries engine 126 within the aATP subsystem 120 can allow the aATP subsystem 120 to return the preliminary delivery terms 140 even when the PP/DS subsystem 130 is temporarily not available (e.g., offline).

The PP/DS subsystem 130 also includes resources 136 (e.g., components, machines, warehouses, labors, etc.) in a production system for manufacturing the products. When the PP/DS subsystem 130 returns the promised delivery terms 140 to the user, relevant resources 136 in the production system for manufacturing the planned quantity of the requested product can be reserved, at least temporarily for a predefined duration (e.g., 5 minutes, 30 minutes, 1 hour, 1 day, etc.), by the PP/DS subsystem 130. In other words, such resources 136 cannot be used for other purposes (e.g., a competing customer order). If the user accepts the promised delivery terms 140 and places the order, then the PP/DS subsystem 130 can commit production of the planned quantity of the product using the reserved resources 136. On the other hand, if the user declines the promised delivery terms 140, the reserved resources 136 can be released to the product system so that they can be used to satisfy other orders.

### Example 3—Example ERP System Integrating Advanced Available-to-Promise Supply Creation Based Confirmation Function

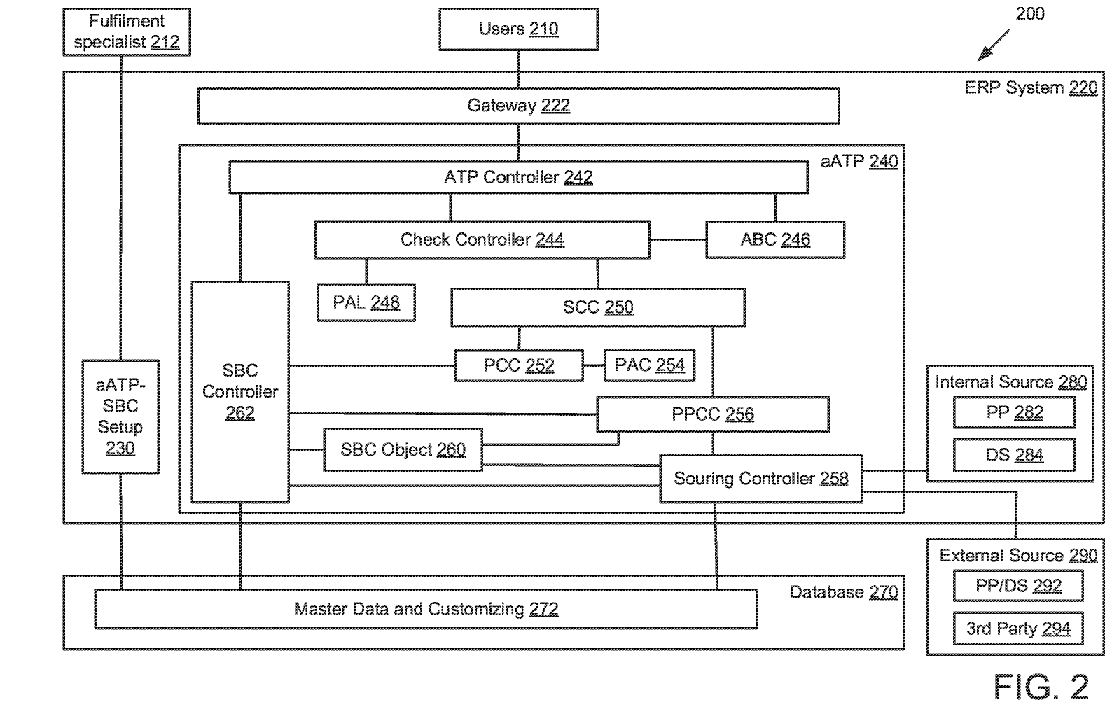

FIG. 2 shows a high-level block diagram of an enterprise environment 200 including an example ERP system 220 in which the aATP-SBC function described above is integrated.

As shown, the enterprise environment 200 includes the ERP system 220 and a database 270 which can be accessed by the ERP system 220. The ERP system 220 includes an aATP subsystem 240 (similar to 120) and an internal source 280 communicating with the aATP subsystem 240. The internal source 280 includes a production planning (PP) object 282 configured to create a production plan after receiving a request to manufacture a product (or a product component), as well as a detailed scheduling (DS) object 284 configured to generate a detailed production schedule corresponding to the created production plan. Optionally, the aATP subsystem 240 can also communicate with an external source 290 provided by a third party and is independent of the ERP system 220. The external source 290 can include its own PP and DS objects 292 and other third-party data or functionalities 294. The internal and external sources 280, 290 can be example embodiments of the PP/DS subsystem 130 described above.

The ERP system 220 includes a gateway 222 through which one or more users 210 (e.g., sales representatives, etc.) can interact with the aATP subsystem 240. For example, through the gateway 222, the users 210 can submit customer orders to the aATP subsystem 240 and receive promised delivery terms (e.g., available quantities and delivery due dates) for the requested products from the aATP subsystem 240.

The aATP subsystem 240 includes an ATP controller 242 which is configured to orchestrate an ATP check which contains the call to various basic methods (executed by the check controller 244) and the handling of substitutions which is performed by alternative based confirmations (ABC) object 246.

The check controller 244 is configured to execute a set of basic methods for product availability check. It can also handle their dependencies. For example, if an allocation already restricts the requested quantity, then the following methods only need to check such reduced quantity. In the depicted example, two types of basic methods are shown: product allocation (PAL) object 248 and supply-demand based capability check (SCC) object 250, which are explained further below.

The ABC object 246 can check possible substitutions (e.g., material and/or plants) for certain products and find the best ones that can satisfy the customer's product request. Thus, if it is not possible to confirm an original product request, the ATP controller 242 can trigger checks for the configured alternatives and determine the most suitable substitution to fulfill the product request as good as possible.

The PAL object 248 is configured to restrict product availability based on allocations. This can occur when there is a committed sale which can restrict product availability before the actual stock is checked by the SCC object 250. In addition, production capacity can also be checked for the quantities of products that were previously confirmed by the SCC object 250.

As described herein, the SCC object 250 can include two parts. First, the SCC object 250 can check available quantities. For this part, the user has the option to select one of two solutions to manage the information on the available quantities. This can be either conventional ATP (i.e., the availability check based on current stock situation and any future, anticipated or planned stock receipts) or the source (e.g., 280 and/or 290). Second, the SCC object 250 can trigger a source (e.g., 280 and/or 290) to produce any missing quantities of the requested product. For this part, the supply creation is not handled by the conventional ATP. Instead, it is always be handled by the source 280 and/or 290. The SCC object 250 can return a delivery confirmation to be conveyed to the user 210. Such delivery confirmation will notify the user 210 the date/time and quantity that the requested product can be fulfilled (either from the stock or from the production by the source).

The product capability check (PCC) object 252 is the check variant where the availability check is handled by ATP in the form of a product availability check (PAC) object 254. If supply needs to be created, a call to the source 280 and/or 290 is required. As described herein, the PAC object 254 is the check to determine the demand-supply situation in the system based on conventional ATP.

The production planning-based capability check (PPCC) object 256 is the check variant where both the availability check and the supply creation are handled by the source 280 and/or 290.

The aATP subsystem 240 also includes an SBC controller 262 which is configured to receive requests for supply creation from PCC object 252 and/or PPCC object 256 and generate an appropriate request to the sourcing controller 258 to get the relevant information (e.g., how much supply can be created at which time) from the source 280 and/or 290. In certain circumstances, the SBC controller 262 can also get an estimated result from a time series (which is described below in more details) to get a faster response while the planning solution is triggered at the same time to get the accurate result. As shown, the SBC controller 262 can communicate with the ATP controller 242. It is called after the ABC controller 246 in the prepare phase of the ATP check and any time supply should be created. This creation of supply can also be a multi-level ATP check simulating the creation of supply via ATP checks on multiple levels of the bill of material (BOM). This can be achieved by calling recursive checks from the SBC controller 262, which can traverse the BOM tree and obtain results for every level. At each level, the SBC controller 262 can decide to create the supply via a source 280 and/or 290 or trigger a component check for the next BOM level.

SBC allows customers to delegate the task of checking product availability and/or planning of unconfirmed quantities to a source (which can be the internal source 280 or the external source 290). It is possible that certain material-plant combinations are checked and/or planned to use one source, whereas some other material-plant combinations are planned to use another source. The sourcing controller 262 is used to determine the correct source for a requirement and trigger the checking and/or planning of requirements. Specifically, the sourcing controller 262 is configured to handle communications with the sources 280, 290. For example, the sourcing controller 262 can identify a relevant source for product planning when multiple internal and/or external sources 280, 290 are connected to the aATP subsystem 240. Thus, all other objects described above (e.g., SCC object 250, PPCC object 256, SBC controller 262, etc.) are source agnostic and make no assumption on the type of source that is called in the end.

The aATP subsystem 240 further includes an SBC object 260, which acts as a central link and can be used to efficiently communicate the necessary data for the availability check (e.g., which material, which requested time, etc.) to the source and vice versa (e.g., product planning results). The SBC object 260 is a data container and can be accessed by both the SBC controller 262 and the SCC object 250 (e.g., via calling PPCC object 256). One of the tasks of the SBC object 260 is to interchange data between the SBC classes. For example, the task to interchange data between a sales order submitted by the user 210 and the SCC object 250 can be handled by the ATP controller 242 in collaboration with the SBC controller 262, which checks if SBC is activated, and if so, then to read the SBC master data stored in the database 270. The SBC object 260 can serve as a unified object for all basic and sourcing methods within SBC to transport requirements and confirmations. The calculated SBC object confirmations can be stored in a check log for review, auditing, and/or reporting purposes. When processing requests for materials that have a complex structure on the parts list level, the SBC object 260 can have one data container per BOM-level, where in each of these containers there can be exactly one flat structure which contains requirements and confirmations.

As shown, the database 270 includes a master data and customizing object 272, which includes a plurality of configurations that can influence how an aATP-SBC based check is executed. For example, some configurations allow customization of conventional ATP (e.g., which basic methods are active, which supply should be considered by the PAC object 254, etc.), and some configurations allows customization of the SBC process (e.g., is PCC object 252 or PPCC object 256 responsible for the supply check, is supply creation activated, how are multi-level availability checks handled, at which point during the check is the supply creation called, etc.).

As shown, the ERP system 220 also includes an aATP-SBC setup object 230, which provides an interface through which a fulfillment specialist 212 can interact with the master data and customizing object 272. Specifically, the fulfillment specialist 212 can set up customizing and master data pertaining to execution of the ATP function and/or implementing the SBC process. For example, this setup can contain both information on the supply creation for the SBC controller 262 and the check execution for the ATP controller 262.

In operation, when the user 210 submits a customer order to the aATP subsystem 240, the ATP controller 242 can call a basic method via the SCC object 250, which can initiate either a production planning based capability check, i.e., the PPCC object 256, or a product capability check (e.g., based on the time series, as described below) via the PCC object 252. As described herein, the term “capability check” denotes a check which not only can check for available material but can also trigger supply creation for a confirmation (if it is activated by customizing via the aATP-SBC setup object 230). In the time series-based (product) capability check, the check for availability is done by the PAC check object 254. In the production planning-based capability check, a call to the sourcing controller 258 is provided to trigger a check in the source 280 and/or 290. In both cases the supply creation part can be handled by a call to the SBC controller 262 which integrates the supply creation into the conventional ATP check.

The SBC controller 262 can then trigger the supply creation in the source 280 and/or 290 via the sourcing controller 258. Via the sourcing controller 258, a connection to the sources 280 and/or 290 can be established. Once the correct source 280 and/or 290 is identified, the production and check processes can be triggered accordingly. The result can be communicated to the SBC controller 262 which can trigger additional steps if needed. For example, in a multilevel process the SBC controller 262 can trigger a follow-up availability check for the relevant components.

Throughout the operations described above, the SBC object 260 can be used to maintain all relevant data regarding requirements and confirmations created in the SBC context. For example, the SBC object 260 can include data that is created over several BOM levels in a multi-level check. The SBC controller 262, the sourcing controller 258, and the production planning-based capability check all have the possibility to access the data stored in the SBC object 260 and can add additional requirements/confirmations therein if needed. The system/subsystems and various operations described above can be further understood in additional examples described below.

In practice, the systems shown herein, such as systems and/or subsystems 100, 120, 130, 200, 220, 240, etc., can vary in complexity, with additional functionality, more complex components, and the like. For example, there can be additional functionality within the ERP system 220. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The systems 100, 200 and any of the other systems and/or subsystems described herein can be implemented in conjunction with any of the hardware components described herein, such as the computing systems described below (e.g., processing units, memory, and the like). In any of the examples herein, the product requests (e.g., input quality parameters), the promised delivery terms, the production model, the timeseries, and the like can be stored in one or more computer-readable storage media or computer-readable storage devices. The technologies described herein can be generic to the specifics of operating systems or hardware and can be applied in any variety of environments to take advantage of the described features.

### Example 4—Example Overall Method of Implementing Advanced Available-to-Promise Supply Creation-Based Confirmation

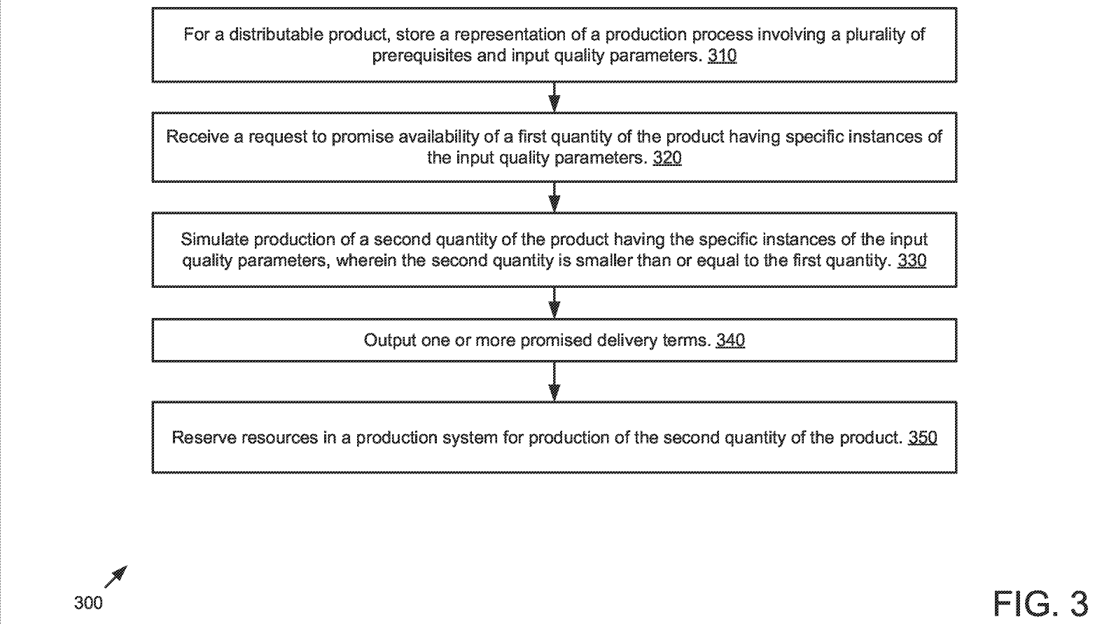

FIG. 3 is a flowchart illustrating an example overall method 300 of implementing the advanced ATP supply creation-based confirmation function. The method 300 can be performed, for example, by the systems depicted in of FIG. 1 and/or FIG. 3.

At 310, for a distributable product, the method can store a representation of a production process involving a plurality of prerequisites and input quality parameters. For example, the representation of the production process can be stored in the production model 132 of the PP/DS subsystem 130, as shown in FIG. 1.

At 320, the method can receive a request to promise availability of a first quantity of the product having specific instances of the input quality parameters. For example, the product request 110 submitted by a user can specify a desired quantity (i.e., the first quantity) of a product having specific instances of input quality parameters, as described above.

At 330, the method can simulate production of a second quantity of the product having the specific instances of the input quality parameters, wherein the second quantity is smaller than or equal to the first quantity. For example, based on the production model 132, the capacity and scheduling simulator 134 can be configured to simulate the production for a planned quantity (i.e., the second quantity) of the product. As noted above, the planned quantity of the product can be the remaining quantity of the product that cannot be fulfilled by the existing product supply 124. Thus, the planned quantity is smaller than the desired quantity if the existing product supply 124 can fulfill at least some of the desired quantity, or equal to the desired quantity if the existing product supply 124 cannot fulfill any of the desired quantity.

At 340, the method can output one or more promised delivery terms. For example, based on the ATP/SBC check 122, the aATP subsystem 120 can present to the user promised delivery terms 140 (i.e., available quantities and delivery due dates) of the requested product, as described above.

At 350, the method can reserve resources in a production system for production of the second quantity of the product. For example, if the SBC availability check is invoked, after presenting the promised delivery terms 140 to the user, relevant resources 136 in the production system for manufacturing the planned quantity of the requested product can be reserved by the PP/DS subsystem 130, as described above.

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 5—Example High-Level Process Flow of Advanced Available-to-Promise Supply Creation-Based Confirmation

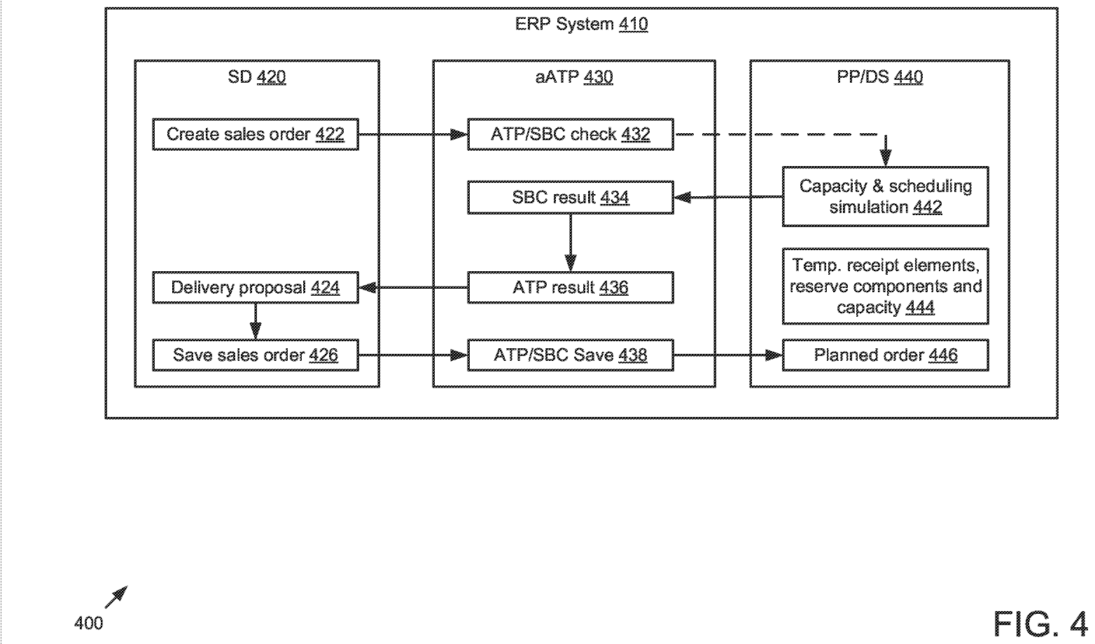

FIG. 4 is a block diagram depicting an example high-level process flow 400 occurred when performing the aATP-SBC function integrated in an ERP system 410 that is similar to the ERP system 220 described above.

As shown, three components of the ERP system 410 are involved in the process flow: the sales and distribution (SD) subsystem 420 which is responsible for sales related tasks (e.g., handling the sales documents), the aATP subsystem 430 (similar to 120 or 240) which is responsible for product availability check, and the PP/DS subsystem (or source) 440 (similar to 130 or 280) which is responsible for advanced planning and scheduling capabilities. Although in the depicted example the PP/DS subsystem 440 is embedded in the ERP system 410, it is to be understood that in certain circumstances the PP/DS subsystem 440 can be external to the ERP system 410 (e.g., similar to 290).

The process flow 400 starts when a customer creates a sales order or any other sales document 422 (which specifies a desired quantity of a product having specific instances of input quality parameters) in the SD subsystem 420. Then the ATP/SBC check 432 (similar to 122) in the aATP subsystem 430 is invoked to check the availability of the product based on the requirements specified in the sales order and specific settings configured for the aATP subsystem 430 (e.g., the aATP settings can be configured through the aATP-SBC setup object 230).

In case the conventional ATP check finds that there is not enough product availability (e.g., the existing product supply 124 cannot fulfill the requested quantity of the product), or the aATP settings indicate no need for availability check in ATP and always producing the product (e.g., in make to order circumstances), the PP/DS subsystem 440 is called to plan production of the product (this is also referred to as the “SBC availability check”). Specifically, capacity and scheduling simulation 442 is performed (e.g., by the capacity and scheduling simulator 134) based on a production model (e.g., 132) to generate a planned quantity and an estimated material availability date for the product. Based on the material availability date, the aATP subsystem 440 can schedule the results (and may work with SD scheduling) to calculate an estimated delivery date of the product. Meanwhile, the PP/DS subsystem 440 can create temporary receipts based on the SBC availability check request and make temporary reservation of relevant resources (e.g., components, capacity, etc.) 444 in the production system for manufacturing the planned quantity of the requested product.

The output of the capacity and scheduling simulation 442 (e.g., material availability date and quantity) can be returned to the aATP subsystem 430 as the result of SBC availability check 434. The aATP subsystem 430 then combines the conventional ATP check result 436 and the SBC availability check result 434 to generate a delivery proposal 424, which can be transmitted to the SD subsystem 420 and presented to the customer.

If the customer is satisfied with the delivery proposal 424, the sales document (created in 422) can be saved 426 in the SD subsystem 420. Saving of the sales document can trigger the aATP subsystem 430 to save the ATP/SBC availability check results 438, and further trigger the PP/DS subsystem 440 to convert the temporary reservation of relevant resources into a planned order 446 so that the PP/DS subsystem 440 can commit production of the planned quantity of the product using the reserved resources.

### Example 6—Example Process Flow of Advanced Available-to-Promise Supply Creation-Based Confirmation Using Timeseries Check

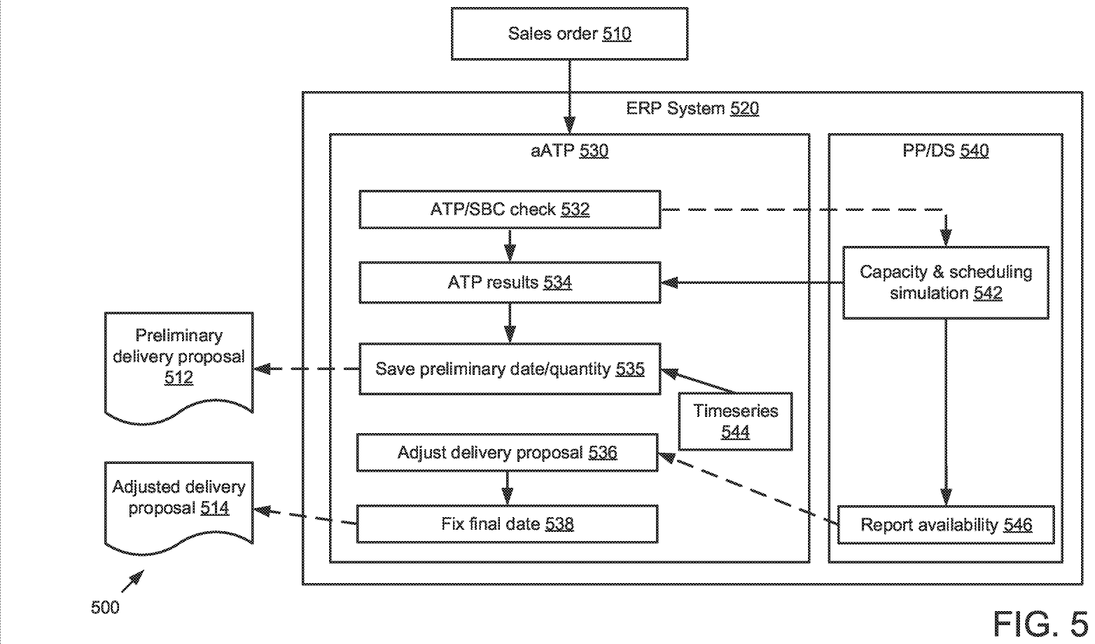

FIG. 5 is a block diagram depicting an example process flow 500 occurred when performing the aATP-SBC function integrated in an ERP system 520 (similar to 220) where the SBC availability check involves timeseries.

Similar to 410, the ERP system 520 includes an aATP subsystem 530 and a PP/DS subsystem (or source) 540. The ERP system 520 can also include an SD subsystem (similar to 420), which is not shown for simplicity.

As shown, after receiving a sales order 510 which specifies a desired quantity of a product having specific instances of input quality parameters, the ATP/SBC check 532 (similar to 122) in the aATP subsystem 530 is invoked to check the availability of the product. If the SBC availability check is called, the PP/DS subsystem 540 can run capacity and scheduling simulation 542 is performed to generate a planned quantity and an estimated material availability date for the product.

In the depicted example, calling of the SBC availability check can be asynchronous to the running of the capacity and scheduling simulation 542. Specifically, while waiting for the completion of the capacity and scheduling simulation 542, the aATP subsystem 530 can immediately return preliminary estimates of planned quantity and material availability date for the product based on timeseries data 544. In other words, the timeseries 544 can be used to perform a fast availability check while the capacity & scheduling simulation 542 is running As noted above, the timeseries data 544 can be pre-generated (e.g., by a timeseries engine 126) based on offline simulation of production of products using various permutations of quality parameters. Thus, the timeseries data 544 could abstract the complexity of the product manufacturing process and represent the free capacities of the PP/DS subsystem 540.

The aATP subsystem 530 can then combine the conventional ATP check results 534 and the preliminary estimates to generate a preliminary delivery proposal 512 and save the preliminary delivery date and quantity of the product 535. When the capacity and scheduling simulation 542 is completed, the PP/DS subsystem 540 can again report an updated product availability 546, based on which the aATP subsystem 530 can adjust the delivery proposal 536, e.g., fixing the delivery date 538 if necessary. The adjusted delivery proposal 514 can then be presented to the customer. Other steps such as reservation of resources, conversion of planned orders after the customer approves the delivery proposal, etc., can also be implemented as described above. For example, relevant resources can be reserved in the production system for manufacturing the planned quantity of the requested product after the preliminary delivery proposal 512 based on the timeseries is presented to the customer.

In certain examples, the timeseries data can be generated using predictive algorithms. In such circumstances, the preliminary estimates of the planned quantity and delivery date may not be 100% accurate, but the preliminary delivery proposal 512 can include a probability figure to indicate the likelihood of accuracy, wherein the probability figure can be generated based on comparison between evaluated and historical data. In certain examples, the timeseries data can also be generated based upon real capacities of the PP/DS subsystem 540. In such circumstances, a probability figure would not be necessary.

### Example 7—Example System to Generate Timeseries

The timeseries can be used to deliver a faster response to a product request submitted by a customer by decoupling complex product planning scenarios from the SBC availability check. As noted above, the timeseries data can abstract the complexity of the sourcing method and represent the free capacities of the source. Thus, using the timeseries data, the advanced ATP integrated with the SBC process, i.e., aATP-SBC, can provide a preliminary delivery proposal including a preliminary delivery date while running the capacity and scheduling simulation to create the supply asynchronously.

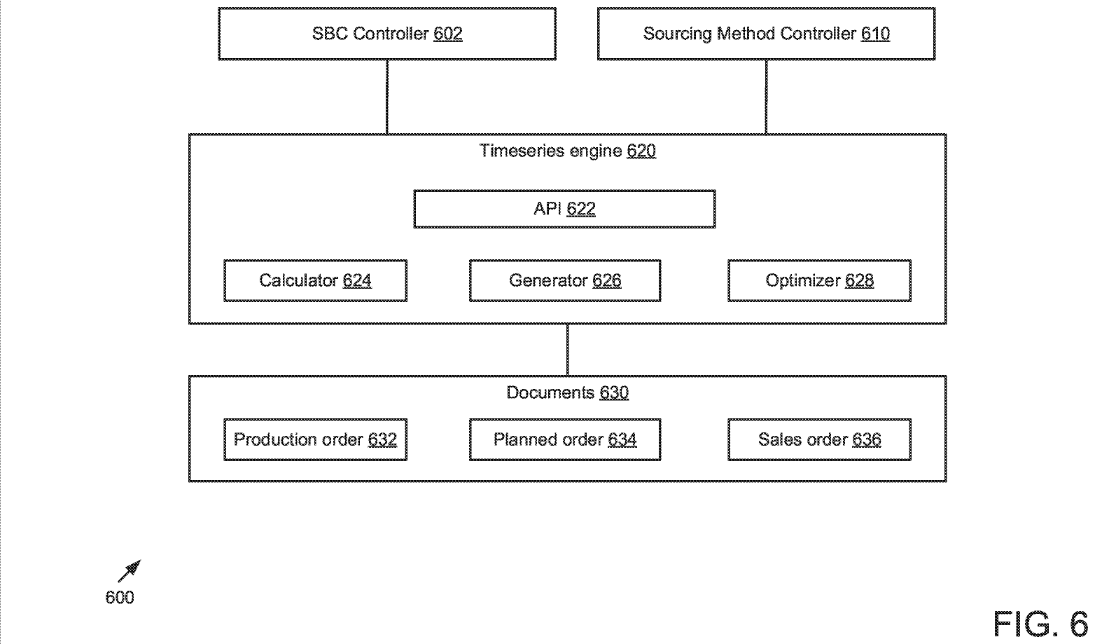

FIG. 6 is a block diagram depicting an example system 600 configured to generate timeseries. The system 600 can be included in any of the aATP subsystems described above (e.g., 120, 240, 430, 530).

As shown, the system 600 includes a timeseries engine 620 which can interact with an SBC controller 602 and a sourcing method controller 610 through an application programming interface (API) 622. The SBC controller 602 can call the timeseries engine 620 to obtain predicted results to replace a real time call of the source, get capacity results and update the timeseries based on new capacity situations within the source, and insert new data points into a timeseries when a source has created supply. The timeseries engine 620 can call the sourcing method controller 610 if it wants the sourcing method controller 610 to fetch data points from the source to write into a timeseries. The timeseries engine 620 can interact with documents 630 (e.g., production order 632, planned order 634, sales order 636, etc.) in order to generate timeseries data out of it. Timeseries can be generated either when a source proactively writes timeseries data via the sourcing method controller 610 or a job collects and translates the documents 630 frequently. Two example use cases for the timeseries include capacity use case and prediction use case. In capacity use case, the timeseries contains free capacities of the source at a certain point in time. In prediction use case, the timeseries contain predicted potential quantities of future time period(s) on finished good level based on history experience. In any case, the generated timeseries can be stored in a timeseries data table for retrieval by the aATP subsystem.

The timeseries engine 620 includes a calculator 624, a generator 626, and an optimizer 628. The generator 626 is configured to generate timeseries data. It can either use the calculator 624 whenever equidistant transformations come into play or just fills the timeseries table with new values. In the predictive use case, the calculator 624 can be used to extrapolate quantities on finished good level and persist it into the timeseries table in advance and even before an order has arrived into the system. In the capacity use case, when a frequent job is applied to collect capacity data from the source, the generator 626 can collect the capacity from the source on finished good level and persists it into the timeseries table. In the predictive use case, the optimizer 628 can be configured to evaluate which of prediction methods is the best one for the current timeseries and select that method for the prediction and set the calculator 624 accordingly. The optimizer 628 can monitor the most frequent used timeseries regularly. Thus, the selected prediction method can change depending on the nature of the timeseries data. In addition, the optimizer 628 can be configured to report the probability of a timeseries usage. This could give the customer an impression whether the timeseries usage would be possible for his/her scenario.

### Example 8—Example Advantages

A number of advantages can be achieved via the technology described herein. For example, compared to conventional ATP technologies which are demand driven and concern little about production planning, the disclosed aATP-SBC function integrates conventional ATP function with a supply creation-based confirmation (SBC) process, thus can achieve more balanced priorities between SD and PP/DS. Specifically, in response to a product request from a customer, the technology disclosed herein can immediately return a delivery proposal to the customer including promised delivery terms (e.g., the quantities and delivery dates for the product). This is achieved by combining both conventional ATP check (which checks existing product supply) and SBC availability check which triggers a simulation production process in the PP/DS to obtain production capacity and estimated material availability time for a planned quantity of the product. Relevant resources can be reserved so that the PP/DS can commit production of the planned quantity of the product using the reserved resources. Importantly, a preliminary delivery proposal can be generated based on timeseries before the completion of the simulation production process while confirmation or modification of the delivery proposal can be presented to the user when the simulation is completed. As a result, the user can receive immediate feedback regarding product availability.

### Example 9—Example Computing Systems

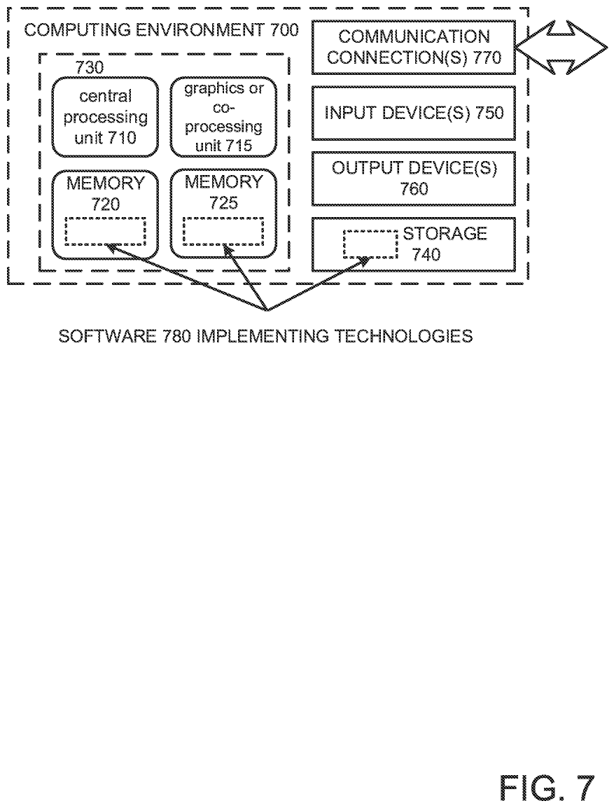

FIG. 7 depicts an example of a suitable computing system 700 in which the described innovations can be implemented. The computing system 700 is not intended to suggest any limitation as to scope of use or functionality of the present disclosure, as the innovations can be implemented in diverse computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 can be volatile memory (e.g., registers, cache, RAM), non-volatile memory (e.g., ROM, EEPROM, flash memory, etc.), or some combination of the two, accessible by the processing unit(s) 710, 715. The memory 720, 725 stores software 780 implementing one or more innovations described herein, in the form of computer-executable instructions suitable for execution by the processing unit(s) 710, 715.

A computing system 700 can have additional features. For example, the computing system 700 includes storage 740, one or more input devices 750, one or more output devices 760, and one or more communication connections 770, including input devices, output devices, and communication connections for interacting with a user. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 can be removable or non-removable, and includes magnetic disks, magnetic tapes or cassettes, CD-ROMs, DVDs, or any other medium which can be used to store information in a non-transitory way and which can be accessed within the computing system 700. The storage 740 stores instructions for the software implementing one or more innovations described herein.

The input device(s) 750 can be an input device such as a keyboard, mouse, pen, or trackball, a voice input device, a scanning device, touch device (e.g., touchpad, display, or the like) or another device that provides input to the computing system 700. The output device(s) 760 can be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 10—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 11—Example Cloud Computing Environment

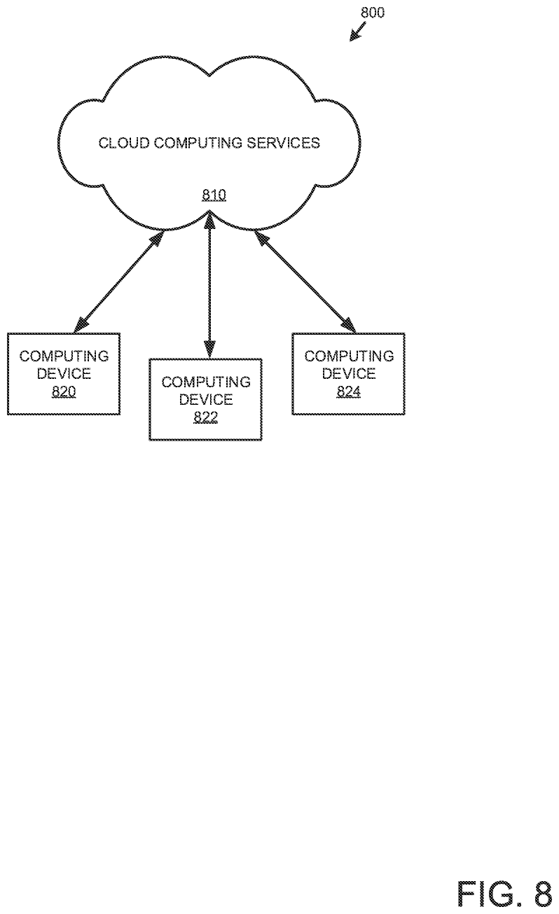

FIG. 8 depicts an example cloud computing environment 800 in which the described technologies can be implemented, including, e.g., the system disclosed above and other systems herein. The cloud computing environment 800 comprises cloud computing services 810. The cloud computing services 810 can comprise various types of cloud computing resources, such as computer servers, data storage repositories, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 are utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

In practice, cloud-based, on-premises-based, or hybrid scenarios can be supported.

### Example 12—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 13—Example Embodiments

Any of the following embodiments can be implemented.

Clauses 1. A computer-implemented method comprising: for a distributable product, storing a representation of a production process involving a plurality of prerequisites and input quality parameters; receiving a request to promise availability of a first quantity of the product having specific instances of the input quality parameters; simulating production of a second quantity of the product having the specific instances of the input quality parameters, wherein the second quantity is smaller than or equal to the first quantity; outputting one or more promised delivery terms; and reserving resources in a production system for production of the second quantity of the product.

Clause 2. The method of clause 1, further comprising: determining a third quantity of the product having the specific instances of the input quality parameters from an existing product supply source; and calculating the second quantity by subtracting the third quantity from the first quantity.

Clause 3. The method of any one of clauses 1-2, further comprising: responsive to acceptance of the promised delivery terms, committing production of the second quantity of the product to the production system using the reserved resources.

Clause 4. The method of any one of clauses 1-3, further comprising: responsive to decline of the promised delivery terms, releasing the reserved resources to the production system.

Clause 5. The method of any one of clauses 1-4, wherein a time interval between receiving the request and outputting one or more promised delivery terms is less than a predefined duration.

Clause 6. The method of any one of clauses 5, wherein the predefined duration ranges from about 1 second to about 10 seconds.

Clause 7. The method of any one of clauses 1-6, wherein outputting one or more promised delivery terms is based on simulated production of the second quantity of the product having the specific instances of the input quality parameters.

Clause 8. The method of any one of clauses 1-7, wherein outputting one or more promised delivery terms is based on time series of estimated product availability data pre-generated.

Clause 9. The method of clause 8, wherein outputting one or more promised delivery terms is performed before completion of the simulated production of the second quantity of the product having the specific instances of the input quality parameters.

Clause 10. The method of clause 9, further comprising confirming or modifying the one or more promised delivery terms after completion of the simulated production of the second quantity of the product having the specific instances of the input quality parameters.

Clause 11. A computing system comprising: memory; one or more hardware processors coupled to the memory; and one or more computer readable storage media storing instructions that, when loaded into the memory, cause the one or more hardware processors to perform operations comprising: for a distributable product, storing a representation of a production process involving a plurality of prerequisites and input quality parameters; receiving a request to promise availability of a first quantity of the product having specific instances of the input quality parameters; simulating production of a second quantity of the product having the specific instances of the input quality parameters, wherein the second quantity is smaller than or equal to the first quantity; outputting one or more promised delivery terms; and reserving resources in a production system for production of the second quantity of the product.

Clause 12. The system of clause 11, wherein the operations further comprise: determining a third quantity of the product having the specific instances of the input quality parameters from an existing product supply source; and calculating the second quantity by subtracting the third quantity from the first quantity.

Clause 13. The system of any one of clauses 11-12, wherein the operations further comprise: responsive to acceptance of the promised delivery terms, committing production of the second quantity of the product to the production system using the reserved resources.

Clause 14. The system of any one of clauses 11-13, wherein the operations further comprise: responsive to decline of the promised delivery terms, releasing the reserved resources to the production system.

Clause 15. The system of any one of clauses 11-14, wherein a time interval between receiving the request and outputting one or more promised delivery terms is less than three seconds.

Clause 16. The system of any one of clauses 11-15, wherein outputting one or more promised delivery terms is based on simulated production of the second quantity of the product having the specific instances of the input quality parameters.

Clause 17. The system of any one of clauses 11-16, wherein outputting one or more promised delivery terms is based on time series of estimated product availability data pre-generated.

Clause 18. The system of clause 18, wherein outputting one or more promised delivery terms is performed before completion of the simulated production of the second quantity of the product having the specific instances of the input quality parameters.

Clause 19. The system of Clause 18, wherein the operations further comprise confirming or modifying the one or more promised delivery terms after completion of the simulated production of the second quantity of the product having the specific instances of the input quality parameters.

Clause 20. One or more computer-readable media having encoded thereon computer-executable instructions causing one or more processors to perform a method comprising: for a distributable product, storing a representation of a production process involving a plurality of prerequisites and input quality parameters; receiving a request to promise availability of a first quantity of the product having specific instances of the input quality parameters; determining a second quantity of the product having the specific instances of the input quality parameters from an existing product supply source; calculating a third quantity by subtracting the second quantity from the first quantity; and simulating production of the third quantity of the product having the specific instances of the input quality parameters; outputting one or more promised delivery terms; reserving resources in a production system for production of the third quantity of the product; and responsive to acceptance of the promised delivery terms, committing production of the third quantity of the product to the production system using the reserved resources; wherein outputting one or more promised delivery terms is based on time series of estimated product availability data pre-generated; wherein outputting one or more promised delivery terms is performed before completion of the simulated production of the third quantity of the product having the specific instances of the input quality parameters.

### Example 14—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computer-implemented method comprising:
for a distributable product, storing a representation of a production process involving a plurality of prerequisites and input quality parameters;
receiving a request to promise availability of a first quantity of the product having specific instances of the input quality parameters;
simulating production of a second quantity of the product having the specific instances of the input quality parameters, wherein the second quantity is smaller than or equal to the first quantity;
outputting one or more promised delivery terms; and
reserving resources in a production system for production of the second quantity of the product.

2. The method of claim 1, further comprising:
determining a third quantity of the product having the specific instances of the input quality parameters from an existing product supply source; and
calculating the second quantity by subtracting the third quantity from the first quantity.

3. The method of claim 1, further comprising:
responsive to acceptance of the promised delivery terms, committing production of the second quantity of the product to the production system using the reserved resources.

4. The method of claim 1, further comprising:
responsive to decline of the promised delivery terms, releasing the reserved resources to the production system.

5. The method of claim 1, wherein a time interval between receiving the request and outputting one or more promised delivery terms is less than a predefined duration.

6. The method of claim 5, wherein the predefined duration ranges from 1 second to 10 seconds.

7. The method of claim 1, wherein outputting one or more promised delivery terms is based on simulated production of the second quantity of the product having the specific instances of the input quality parameters.

8. The method of claim 1, wherein outputting one or more promised delivery terms is based on time series of estimated product availability data pre-generated.

9. The method of claim 8, wherein outputting one or more promised delivery terms is performed before completion of the simulated production of the second quantity of the product having the specific instances of the input quality parameters.

10. The method of claim 9, further comprising confirming or modifying the one or more promised delivery terms after completion of the simulated production of the second quantity of the product having the specific instances of the input quality parameters.

11. A computing system comprising:
memory;
one or more hardware processors coupled to the memory; and
one or more computer readable storage media storing instructions that, when loaded into the memory, cause the one or more hardware processors to perform operations comprising:
for a distributable product, storing a representation of a production process involving a plurality of prerequisites and input quality parameters;
receiving a request to promise availability of a first quantity of the product having specific instances of the input quality parameters;
simulating production of a second quantity of the product having the specific instances of the input quality parameters, wherein the second quantity is smaller than or equal to the first quantity;
outputting one or more promised delivery terms; and
reserving resources in a production system for production of the second quantity of the product.

12. The system of claim 11, wherein the operations further comprise:
determining a third quantity of the product having the specific instances of the input quality parameters from an existing product supply source; and
calculating the second quantity by subtracting the third quantity from the first quantity.

13. The system of claim 11, wherein the operations further comprise:
responsive to acceptance of the promised delivery terms, committing production of the second quantity of the product to the production system using the reserved resources.

14. The system of claim 11, wherein the operations further comprise:
responsive to decline of the promised delivery terms, releasing the reserved resources to the production system.

15. The system of claim 11, wherein a time interval between receiving the request and outputting one or more promised delivery terms is less than three seconds.

16. The system of claim 11, wherein outputting one or more promised delivery terms is based on simulated production of the second quantity of the product having the specific instances of the input quality parameters.

17. The system of claim 11, wherein outputting one or more promised delivery terms is based on time series of estimated product availability data pre-generated.

18. The system of claim 18, wherein outputting one or more promised delivery terms is performed before completion of the simulated production of the second quantity of the product having the specific instances of the input quality parameters.

19. The system of claim 18, wherein the operations further comprise confirming or modifying the one or more promised delivery terms after completion of the simulated production of the second quantity of the product having the specific instances of the input quality parameters.

20. One or more computer-readable media having encoded thereon computer-executable instructions causing one or more processors to perform a method comprising:
for a distributable product, storing a representation of a production process involving a plurality of prerequisites and input quality parameters;
receiving a request to promise availability of a first quantity of the product having specific instances of the input quality parameters;
determining a second quantity of the product having the specific instances of the input quality parameters from an existing product supply source;
calculating a third quantity by subtracting the second quantity from the first quantity; and
simulating production of the third quantity of the product having the specific instances of the input quality parameters;
outputting one or more promised delivery terms;
reserving resources in a production system for production of the third quantity of the product; and
responsive to acceptance of the promised delivery terms, committing production of the third quantity of the product to the production system using the reserved resources;
wherein outputting one or more promised delivery terms is based on time series of estimated product availability data pre-generated;
wherein outputting one or more promised delivery terms is performed before completion of the simulated production of the third quantity of the product having the specific instances of the input quality parameters.
